(19) United States
(12) Patent Application Publication
(10) Pub. No.: US 2026/0302497 A1
(43) Pub. Date: Oct. 1, 2026

(54) POWER STORAGE DEVICE

(71) Applicant: TOYOTA JIDOSHA KABUSHIKI KAISHA, Toyota-shi (JP)

(72) Inventor: Ryo SAKURADA, Nisshin-shi (JP)

(73) Assignee: TOYOTA JIDOSHA KABUSHIKI KAISHA, Toyota-shi (JP)

(21) Appl. No.: 19/444,607

(22) Filed: Jan. 9, 2026

(30) Foreign Application Priority Data
Mar. 26, 2025 (JP) 2025-052493

(51) Int. Cl. H01M 50/289; H01M 10/613; H01M 10/653; H01M 10/6555; H01M 50/204; H01M 50/503

(52) U.S. Cl. CPC H01M 50/289; H01M 10/613; H01M 10/653; H01M 10/6555; H01M 50/204; H01M 50/503

(57) ABSTRACT

A power storage device includes a case, a power storage module housed inside the case, a cooler that is housed inside the case and is stacked on the power storage module in a Z-direction, and a filler that fills a space between the case and the cooler in an X-direction that intersects the Z-direction. The cooler has a through hole that extends through the cooler in the Z-direction and is filled with the filler.

### CROSS-REFERENCE TO RELATED APPLICATION

This application claims priority to Japanese Patent Application No. 2025-052493 filed on Mar. 26, 2025. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2018-81820 (JP 2018-81820 A) discloses a battery including a cell case in which a stack is disposed. The stack includes at least stacked unit cells, a deformation absorbing portion disposed between a lid member and the stacked unit cells, and an anisotropic extensible portion located on the outer peripheral portion of the unit cells.

### SUMMARY

In addition to battery cells, members (such as a cooler for cooling the battery cells) may be housed inside a case of a power storage device to overlap the battery cells. In such a power storage device in which the members are housed inside the case, when an external load is input to the power storage device, an inertial force acts on the members inside the case. Therefore, the members housed in the case may move inside the case.

In view of the above fact, an object of the present disclosure is to provide a power storage device in which movement of a housed member that is housed in a case can be suppressed inside the case.

A power storage device according to a first aspect includes: a case; a power storage module housed inside the case; a housed member that is housed inside the case and is stacked on the power storage module in a predetermined direction; and a filler that fills a space between the case and the housed member in an intersecting direction that intersects the predetermined direction. The housed member has a through hole that extends through the housed member in the predetermined direction and is filled with the filler.

In the power storage device according to the first aspect, the housed member has the through hole that extends through the housed member in the predetermined direction and is filled with the filler. When an external load is input to the power storage device, an inertial force acts on the housed member inside the case, causing the housed member to move inside the case. When the housed member attempts to move, the surface that defines the through hole is received by the resin that fills the through hole. Therefore, the movement of the housed member (particularly movement in the direction intersecting the predetermined direction) is restricted. Thus, the movement of the housed member that is housed in the case can be suppressed inside the case.

A power storage device according to a second aspect includes: a case; a power storage module housed inside the case; a housed member that is housed inside the case and is stacked on the power storage module in a predetermined direction; and a filler that fills a space between the case and the housed member in an intersecting direction that intersects the predetermined direction. An edge of the housed member in the intersecting direction has a cutout filled with the filler.

In the power storage device according to the second aspect, the edge of the housed member has the cutout. When an external load is input to the power storage device, an inertial force acts on the housed member inside the case, causing the housed member to move inside the case. When the housed member attempts to move, the surface that defines the cutout is received by the resin that fills the cutout. Therefore, the movement of the housed member (particularly movement in the direction intersecting the predetermined direction) is restricted. Thus, the movement of the housed member that is housed in the case can be suppressed inside the case.

A power storage device according to a third aspect includes: a case; a power storage module housed inside the case; a housed member that is housed inside the case and is stacked on the power storage module in a predetermined direction; and a filler that fills a space between the case and the housed member in an intersecting direction that intersects the predetermined direction. The housed member includes a plurality of plate-shaped members stacked in the predetermined direction, and an end of the housed member in the intersecting direction includes a spaced portion in which the plate-shaped members are spaced away from each other.

In the power storage device according to the third aspect, the end of the housed member includes the spaced portion in which the plate-shaped members are spaced away from each other. Therefore, the filler enters the spaced portion to improve the adhesive strength between the filler and the housed member. When an external load is input to the power storage device, an inertial force acts on the housed member inside the case, causing the housed member to move inside the case. Since the adhesive strength between the filler and the housed member is improved, the movement of the housed member (particularly movement in the direction intersecting the predetermined direction) is restricted. Thus, the movement of the housed member that is housed in the case can be suppressed inside the case.

In a power storage device according to a fourth aspect, in any one of the first to third aspects, an end of the housed member in the intersecting direction is located inward, in the intersecting direction, of an end of the power storage module in the intersecting direction when viewed in the predetermined direction.

In the power storage device according to the fourth aspect, the end of the housed member in the intersecting direction is located inward, in the intersecting direction, of the end of the power storage module in the intersecting direction when viewed in the predetermined direction. Therefore, when an external load is input to the power storage device, the load is less likely to be transmitted to the housed member. Thus, the movement of the housed member that is housed in the case can be suppressed inside the case.

In a power storage device according to a fifth aspect, in any one of the first to fourth aspects, a plurality of the power storage modules is provided, and the housed member is provided between the power storage modules adjacent to each other and provides a conductive connection path between the power storage modules adjacent to each other.

In the power storage device according to the fifth aspect, the housed member is provided between the power storage modules and provides the conductive connection path between the power storage modules adjacent to each other. Thus, an increase in electrical resistance can be suppressed.

As described above, the power storage device according to the present disclosure has the excellent effect that the movement of the housed member that is housed in the case can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an enlarged vertical sectional view of a main part of a power storage device according to a first embodiment of the present disclosure;

FIG. 2 is a plan view showing a cooler provided in the power storage device according to the first embodiment of the present disclosure;

FIG. 3 is a plan view showing a main part of the cooler provided in the power storage device according to the first embodiment of the present disclosure;

FIG. 4 is a plan view showing a main part of a cooler provided in a power storage device according to a modification of the first embodiment of the present disclosure;

FIG. 5 is a plan view showing a main part of a cooler provided in a power storage device according to a second embodiment of the present disclosure;

FIG. 6 is a perspective view showing a main part of a cooler provided in a power storage device according to a third embodiment of the present disclosure; and

FIG. 7 is a sectional view taken along line 7-7 in FIG. 6.

### DETAILED DESCRIPTION OF EMBODIMENTS

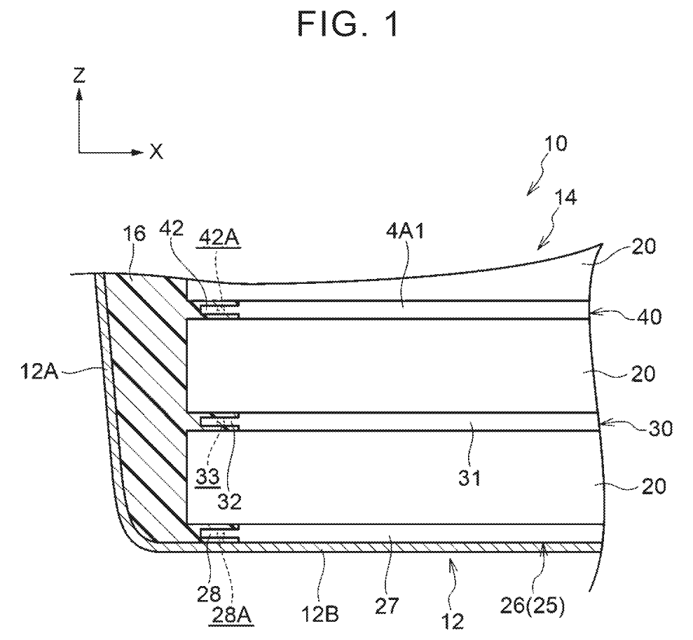

Power storage devices according to embodiments of the present disclosure will be described below with reference to FIGS. 1 to 7. In the following description and in the drawings, a Z-direction (predetermined direction) is a stacking direction of the stack housed inside the power storage device. An X-direction (intersecting direction) is a longitudinal direction of the power storage device in a plane orthogonal to the Z-direction. A Y-direction (intersecting direction) is a direction orthogonal to the X-direction and the Z-direction, and is a transverse direction of the power storage device in a plane orthogonal to the Z-direction. In the embodiments, the Z-direction is an up-down direction.

### First Embodiment

A power storage device 10 according to the present embodiment is mounted on a vehicle. The vehicle to which the power storage device 10 according to the present embodiment is applied is, for example, a battery electrified vehicle (BEV: Battery Electric Vehicle). The vehicle to which the power storage device 10 according to the present embodiment can be applied is not limited to the BEV. For example, the power storage device 10 according to the present embodiment may be applied to a hybrid electric vehicle (HEV) or a plug-in hybrid electric vehicle (PHEV).

As shown in FIG. 1, the power storage device 10 includes a case 12, a stack 14 housed inside the case 12, and a filler 16 that fills a space between the inner peripheral surface of the case 12 and the stack 14.

The case 12 is a box-shaped member that forms a space inside. The case 12 includes a ceiling portion (not shown) that defines the upper end of the internal space, sidewall portions 12A that define the sides of the internal space, and a bottom plate portion 12B that defines the lower end of the internal space.

The ceiling portion is a plate-shaped member that covers the stack 14 from the top. The bottom plate portion 12B is a plate-shaped member that covers the stack 14 from the bottom. The sidewall portions 12A are plate-shaped members that cover the stack 14 from the sides. The sidewall portions 12A connect the ceiling portion and the bottom plate portion 12B.

The stack 14 includes a plurality of power storage modules 20, a current collecting plate (housed member) 25 provided between the power storage module 20 and the case 12, and a cooler (housed member) 30 and a conductive plate (housed member) 40 provided between the power storage modules 20. The stack 14 includes the power storage modules 20, the current collecting plate 25, the cooler 30, and the conductive plate 40 that are stacked one on top of the other.

A plurality of power storage modules 20 is provided. The power storage modules 20 are arranged in the Z-direction. The power storage module 20 is a secondary battery. The power storage module 20 includes a substantially rectangular parallelepiped case and a plurality of battery cells (not shown) housed inside the case. The power storage module 20 according to the present embodiment may be a so-called bipolar battery. More specifically, the power storage module 20 may be, for example, a laminated aqueous lithium-ion battery or a nickel-metal hydride battery. The power storage module 20 is not limited to the bipolar battery described above, and may be, for example, an all-solid-state battery or a capacitor.

The current collecting plate 25 is a plate made of a conductive material. The current collecting plate 25 includes an upper current collecting plate (not shown) and a lower current collecting plate 26. The upper current collecting plate is stacked on the top of the power storage module 20 that is located at the top in the stacking direction (Z-direction) of the power storage modules 20. The upper current collecting plate is a cathode current collecting plate and is connected to a cathode terminal (not shown). The lower current collecting plate 26 is stacked on the bottom of the power storage module 20 that is located at the bottom in the stacking direction (Z-direction) of the power storage modules 20. The lower current collecting plate 26 is an anode current collecting plate and is connected to an anode terminal (not shown).

The current collecting plate 25 has a rectangular shape with its long side in the X-direction and its short side in the Y-direction in plan view. The current collecting plate 25 includes a base portion 27 provided at the center in the X-direction and the Y-direction, and outer edge portions 28 provided at the ends in the X-direction and the Y-direction.

One of the upper surface and the lower surface of the base portion 27 is in contact with the adjacent power storage module 20. The other of the upper surface and the lower surface of the base portion 27 is in contact with the adjacent case 12.

The outer edge portions 28 are provided to protrude outward from the ends of the base portion 27 in the X-direction and the Y-direction. The length of the outer edge portion 28 in the stacking direction is smaller than the length of the base portion 27 in the stacking direction. The upper surface and the lower surface of the outer edge portion 28 are not in contact with the power storage module 20 or the case 12. The end of the outer edge portion 28 in the X-direction is located inward of the end of the power storage module 20 in the X-direction. The end of the outer edge portion 28 in the Y-direction is located inward of the end of the power storage module 20 in the Y-direction. The outer edge portion 28 has a plurality of through holes 28A extending through the outer edge portion 28 in the stacking direction.

The shape of the through hole 28A is the same as the shape of a through hole 33 formed in the cooler 30 described later. That is, the through hole has an oblong shape in which the length in the X-direction is larger than the length in the Y-direction. The through hole 28A is formed at the same position as that of the through hole 33 formed in the cooler 30 described later. That is, the through holes 28A are arranged at predetermined intervals along the long and short sides. The through holes 28A arranged along the long side are provided over substantially the entire region in the X-direction. The through holes 28A arranged along the short side are provided only at both ends in the Y-direction, and not provided at the center in the Y-direction. The through hole 28A communicates with a space between the case 12 and the stack 14. Therefore, the through hole 28A is filled with the filler 16.

The cooler 30 is made of a material having high thermal conductivity. The cooler 30 is a substantially plate-shaped member. The cooler 30 is provided between the power storage modules 20 adjacent to each other in the stacking direction (Z-direction). The upper surface and the lower surface of the cooler 30 are in contact with the power storage modules 20. The cooler 30 includes a coolant channel (not shown) through which a coolant can flow, and cools the power storage modules 20 with the coolant flowing through the coolant channel. The specific cooling structure of the cooler 30 is not limited to the one described above, and various structures can be adopted as long as they can provide a cooling function. The cooler 30 is made of a conductive material and provides a conductive connection path between the adjacent power storage modules 20.

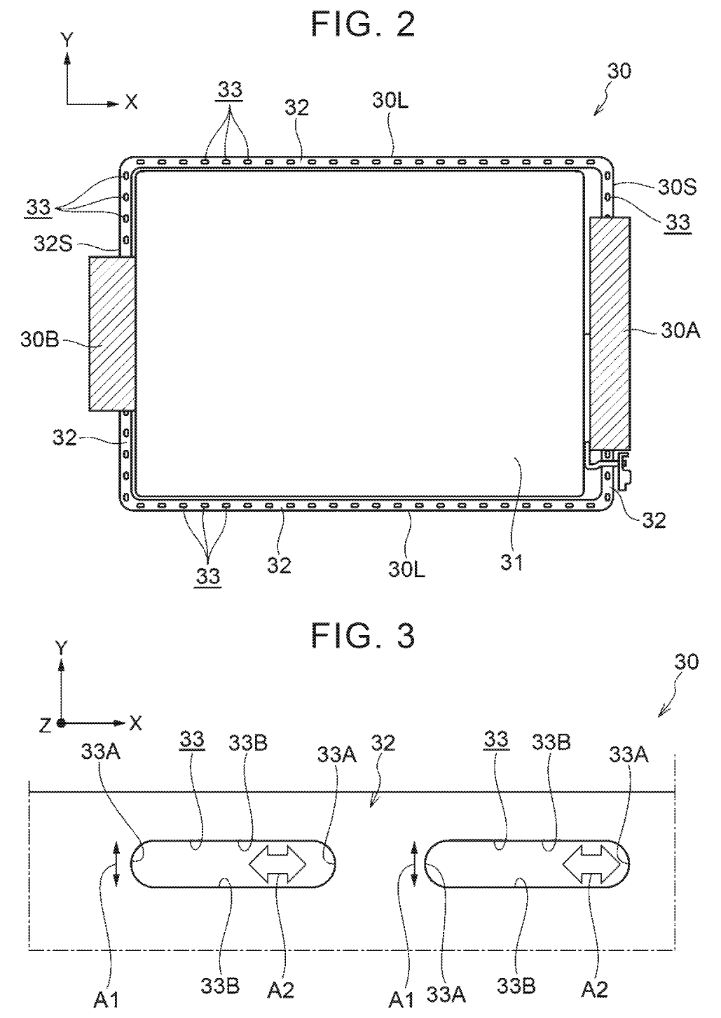

As shown in FIG. 2, the cooler 30 has a rectangular shape in plan view with a long side 30L in the X-direction and a short side 30S in the Y-direction. The cooler 30 includes a base portion 31 provided at the center in the X-direction and the Y-direction, and outer edge portions 32 provided at the ends in the X-direction and the Y-direction.

As shown in FIG. 1, the upper surface and the lower surface of the base portion 31 are in contact with the adjacent power storage modules 20. The base portion 31 includes a coolant channel. As shown in FIG. 2, the coolant channel has, at the center of one short side 30S of the base portion 31, an inlet 30A through which the coolant flows in. The coolant channel has, at the center of the other short side 30S of the base portion 31, an outlet 30B through which the coolant flows out.

The outer edge portions 32 are provided to protrude outward from the ends of the base portion 31 in the X-direction and the Y-direction. The length of the outer edge portion 32 in the stacking direction is smaller than the length of the base portion 31 in the stacking direction. The upper surface and the lower surface of the outer edge portion 32 are not in contact with the power storage module 20 or the case 12. As shown in FIG. 1, the end of the outer edge portion 32 in the X-direction is located inward of the end of the power storage module 20 in the X-direction. The end of the outer edge portion 32 in the Y-direction is located inward of the end of the power storage module 20 in the Y-direction. The outer edge portion 32 has a plurality of through holes 33 extending through the outer edge portion 32 in the stacking direction.

As shown in FIGS. 2 and 3, the through hole 33 has an oblong shape in which the length in the X-direction is larger than the length in the Y-direction. As shown in FIG. 2, the through holes 33 are arranged at predetermined intervals along the long and short sides. The through holes 33 arranged along the long side are provided over substantially the entire region in the X-direction. The through holes 33 arranged along the short side are provided only at both ends in the Y-direction, and not provided at the center in the Y-direction. This is to avoid interference between the inlet and outlet of the coolant and the outer edge portions 32 having the through holes 33. The through hole 33 communicates with a space between the case 12 and the stack 14. Therefore, the through hole 33 is filled with the filler 16.

The conductive plate 40 is a plate having electrical conductivity. As shown in FIG. 1, the conductive plate 40 is provided between the power storage modules 20 adjacent to each other in the stacking direction (Z-direction). The upper surface and the lower surface of the conductive plate 40 are in contact with the power storage modules 20. The conductive plate 40 electrically connects the adjacent power storage modules 20. The conductive plate 40 is made of a material having high thermal conductivity. By forming the conductive plate 40 using the material having high thermal conductivity, the conductive plate 40 is less likely to impede the cooling effect of the cooler 30. By using the conductive plate 40 in an appropriate location, the number of coolers 30 used in the power storage device 10 can be adjusted, and the manufacturing costs of the power storage device 10 can be reduced. The cooler 30 may be disposed instead of the conductive plate 40, and the conductive plate 40 may be omitted.

The conductive plate 40 has a rectangular shape with its long side in the X-direction and its short side in the Y-direction in plan view. The conductive plate 40 includes a base portion 41 provided at the center in the X-direction and the Y-direction, and outer edge portions 42 provided at the ends in the X-direction and the Y-direction.

One of the upper surface and the lower surface of the base portion 41 is in contact with the adjacent power storage module 20. The other of the upper surface and the lower surface of the base portion 41 is in contact with the adjacent case 12.

The outer edge portions 42 are provided to protrude outward from the ends of the base portion 41 in the X-direction and the Y-direction. The length of the outer edge portion 42 in the stacking direction is smaller than the length of the base portion 41 in the stacking direction. The upper surface and the lower surface of the outer edge portion 42 are not in contact with the power storage module 20. The end of the outer edge portion 42 in the X-direction is located inward of the end of the power storage module 20 in the X-direction. The end of the outer edge portion 42 in the Y-direction is located inward of the end of the power storage module 20 in the Y-direction. The outer edge portion 42 has a plurality of through holes 42A extending through the outer edge portion 42 in the stacking direction.

The shape of the through hole 42A is the same as the shape of the through hole 33 formed in the cooler 30 described above. That is, the through hole has an oblong shape in which the length in the X-direction is larger than the length in the Y-direction. The through hole 42A is formed at the same position as that of the through hole 33 formed in the cooler 30 described above. That is, the through holes 42A are arranged at predetermined intervals along the long and short sides. The through holes 42A arranged along the long side are provided over substantially the entire region in the X-direction. The through holes 42A arranged along the short side are provided only at both ends in the Y-direction, and not provided at the center in the Y-direction. The through hole 42A communicates with a space between the case 12 and the stack 14. Therefore, the through hole 42A is filled with the filler 16.

As shown in FIG. 1, the filler 16 mainly fills spaces (hereinafter referred to as "filled spaces") between the inner surface of the case 12 and the ends of the stack 14 in the X-direction and the Y-direction. The filler 16 is made of, for example, a filling material. The filler 16 fills the filled spaces in a molten state and is then cured in the filled spaces. The filler 16 adheres to the inner surface of the case 12 and the ends of the stack 14 in the X-direction and the Y-direction.

The filler 16 fills the space between the outer edge portion 28 of the current collecting plate 25 and the power storage module 20. The filler 16 also fills the space between the outer edge portion 28 of the current collecting plate 25 and the bottom plate portion 12B of the case 12. The filler 16 also fills the through holes 28A formed in the outer edge portion 28. The filler 16 that fills the filled spaces and the filler 16 that fills the through holes 28A are provided as a single component.

The filler 16 fills the space between the outer edge portion 32 of the cooler 30 and the power storage module 20. The filler 16 also fills the through holes 33 formed in the outer edge portion 32. The filler 16 that fills the filled spaces and the filler 16 that fills the through holes 33 are provided as a single component.

The filler 16 fills the space between the outer edge portion 42 of the conductive plate 40 and the power storage module 20. The filler 16 also fills the through holes 42A formed in the outer edge portion 42. The filler 16 that fills the filled spaces and the filler 16 that fills the through holes 42A are provided as a single component.

According to the present embodiment, the following actions and effects are achieved.

As shown in FIG. 1, in the present embodiment, the stack 14 (particularly the current collecting plate 25, the cooler 30, and the conductive plate 40) housed in the case 12 has the through holes 28A, 33, 42A that extend through the stack 14 in the stacking direction and are filled with the filler 16. For example, when a vehicle collides, an external load is input to the power storage device 10. When the external load is input to the power storage device 10, an inertial force acts on the stack 14 inside the case 12, causing the stack 14 to move inside the case 12. When the stack 14 attempts to move, the stack 14 is received by the resin that fills the through holes 28A, 33, 42A. Therefore, the movement of the stack 14 is restricted. In other words, the movement of the stack 14 is restricted by an anchor effect of the filler 16 that fills the through holes 28A, 33, 42A. Thus, the movement of the stack 14 housed in the case 12 can be suppressed inside the case 12.

The effect of suppressing the movement of the stack 14 will be described in detail with reference to FIG. 3. In the following description, the effect of suppressing movement of the cooler 30 in the stack 14 will be described as an example.

As shown in FIG. 3, the outer edge portion 32 of the cooler 30 has the through hole 33 extending through the outer edge portion 32 in the Z-direction. The through hole 33 is filled with the filler 16 (see FIG. 1). The outer edge portion 32 of the cooler 30 includes end faces (hereinafter referred to as "first end faces 33A") provided at both ends of the inner surface of the through hole 33 in the X-direction, and end faces (hereinafter referred to as "second end faces 33B") provided at both ends of the inner surface of the through hole 33 in the Y-direction. The first end face 33A and the second end face 33B have components in the Z-direction. When the cooler 30 and the filler 16 attempt to move relatively in the X-direction (see arrow A2), the first end face 33A receives the load in the X-direction input from the filler 16. Therefore, the first end face 33A restricts the relative movement between the cooler 30 and the filler 16 in the X-direction. When the cooler 30 and the filler 16 attempt to move relatively in the Y-direction (see arrow A1), the second end face 33B receives the load in the Y-direction input from the filler 16. Therefore, the second end face 33B restricts the relative movement between the cooler 30 and the filler 16 in the Y-direction.

In this way, in the present embodiment, the first end face 33A and the second end face 33B of the cooler 30 receive the loads input from the filler 16. Therefore, the movement of the cooler 30 housed in the case 12 can be suppressed inside the case 12. Similarly, the current collecting plate 25 and the conductive plate 40 have the through holes similar to those in the cooler 30. Therefore, the movement of the current collecting plate 25 and the conductive plate 40 housed in the case 12 can be suppressed inside the case 12.

In the present embodiment, the through holes 28A, 33, 42A are formed, and therefore the number of surfaces that receive the loads can be increased. Thus, the movement of the stack 14 housed in the case 12 can be suppressed more suitably inside the case 12.

In the present embodiment, the ends of the current collecting plate 25, the cooler 30, and the conductive plate 40 in the X-direction and the Y-direction are located inward of the ends of the power storage module 20 in the X-direction and the Y-direction when viewed in the Z-direction. Therefore, when an external load is input to the power storage device 10, the load is less likely to be transmitted to the current collecting plate 25, the cooler 30, and the conductive plate 40. Thus, the movement of the current collecting plate 25, the cooler 30, and the conductive plate 40 housed in the case 12 can be suppressed inside the case 12.

In the present embodiment, the cooler 30 and the conductive plate 40 are each provided between the power storage modules 20 and provide a conductive connection path between the adjacent power storage modules 20. Thus, an increase in electrical resistance can be suppressed.

### Modifications

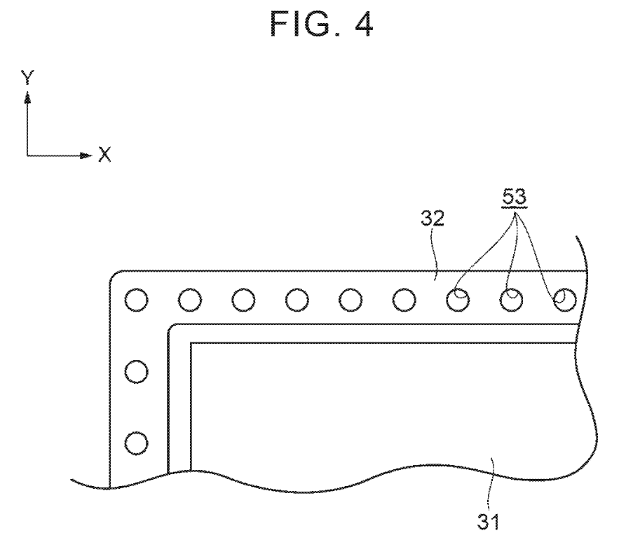

The shape of the through hole 33 formed in the cooler 30 is not limited to the shape described in the above embodiment. For example, as shown in FIG. 4, the cooler 30 may have a through hole 53 that has a perfectly circular shape when viewed in the X-direction. The through holes provided in the current collecting plate 25 and the through holes provided in the conductive plate 40 may similarly have a perfectly circular shape. The shape of each through hole may be any other shape (for example, a polygonal or elliptical shape).

### Second Embodiment

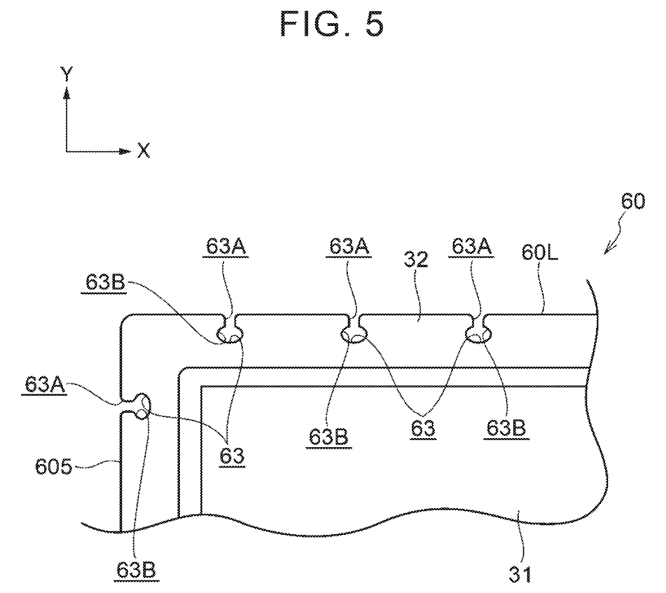

Next, a power storage device according to a second embodiment of the present disclosure will be described with reference to FIG. 5. The power storage device according to the present embodiment differs from the power storage device according to the first embodiment in that the current collecting plate 25, the cooler 30, and the conductive plate 40 have cutouts instead of the through holes. The other points are the same as those in the first embodiment. Therefore, the same components are denoted by the same reference numerals and detailed description thereof will be omitted.

As shown in FIG. 5, a plurality of cutouts 63 is provided in the outer edge portions 32 of a cooler 60 according to the present embodiment. The cutout 63 is provided on the outer edge of the cooler 60. The cutout 63 provided along a long side 60L of the cooler 60 includes an inlet 63A provided outward in the Y-direction, and an enlarged portion 63B provided inward of the inlet 63A in the Y-direction. Similarly, the cutout 63 provided along a short side 60S of the cooler 60 includes an inlet 63A provided outward in the X-direction, and an enlarged portion 63B provided inward of the inlet 63A in the X-direction.

The length of the enlarged portion 63B in the width direction (the direction intersecting the direction in which the cutout 63 extends from the edge) is larger than the length of the inlet 63A in the width direction. That is, the cutout 63 is enlarged such that the length in the width direction is larger on the inner side.

The cutout 63 is formed at the same position as that of the through hole 33 formed in the cooler 30 of the first embodiment. That is, the cutouts 63 are arranged at predetermined intervals along the long side 60L and the short side 60S of the cooler 60. The cutouts 63 arranged along the long side 60L are provided over substantially the entire region in the X-direction. The cutouts 63 arranged along the short side 60S are provided only at both ends in the Y-direction, and not provided at the center in the Y-direction. The cutout 63 communicates with a space between the case 12 and the stack 14. Therefore, the cutout 63 is filled with the filler 16.

In the present embodiment, the current collecting plate 25 and the conductive plate 40 also have cutouts similar to those in the cooler 60.

According to the present embodiment, the following actions and effects are achieved.

In the present embodiment, the cutout 63 is provided on the edge of the cooler 60. For example, when a vehicle collides, an external load is input to the power storage device 10. When the external load is input to the power storage device 10, an inertial force acts on the cooler 60 inside the case 12, causing the cooler 60 to move inside the case 12. When the cooler 60 attempts to move, the cooler 60 is received by the resin that fills the cutout 63. Therefore, the movement of the cooler 60 is restricted. In other words, the movement of the cooler 60 is restricted by an anchor effect of the filler 16 that fills the cutout 63. Thus, the movement of the cooler 60 housed in the case 12 can be suppressed inside the case 12.

In the present embodiment, the cutout 63 includes the inlet 63A and the wide enlarged portion 63B. In this way, the cutout 63 is enlarged such that the length in the width direction is larger on the inner side. Therefore, the filler 16 that fills the cutout 63 can exhibit the anchor effect more suitably. Thus, the movement of the cooler 60 housed in the case 12 can be suppressed more suitably inside the case 12.

### Third Embodiment

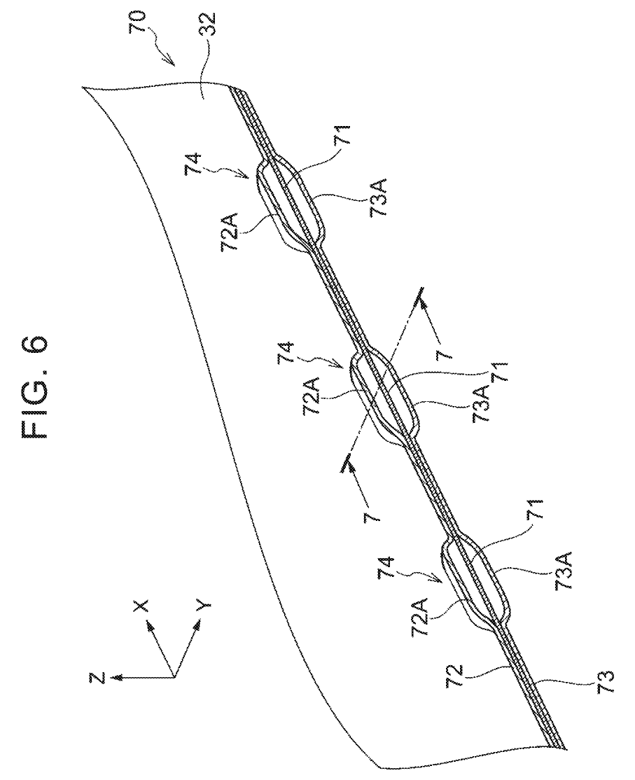

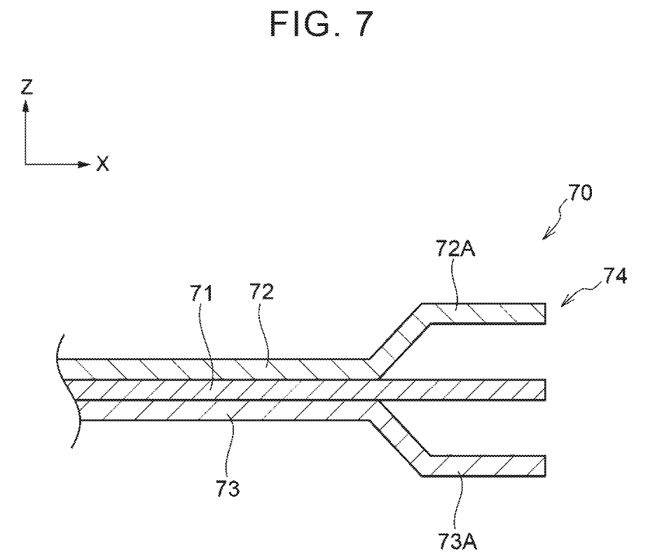

Next, a power storage device according to a third embodiment of the present disclosure will be described with reference to FIGS. 6 and 7. The power storage device according to the present embodiment differs from the power storage device according to the first embodiment in that the cooler 30 has spaced portions instead of the through holes. The other points are the same as those in the first embodiment. Therefore, the same components are denoted by the same reference numerals and detailed description thereof will be omitted.

As shown in FIGS. 6 and 7, a cooler 70 of the present embodiment includes a middle plate (plate-shaped member) 71, an upper plate (plate-shaped member) 72 provided above the middle plate 71, and a lower plate (plate-shaped member) 73 provided below the middle plate 71. The cooler 70 includes the middle plate 71, the upper plate 72, and the lower plate 73 that are stacked in the up-down direction.

The upper surface of the middle plate 71 is in contact with and joined to the upper plate 72. The lower surface of the middle plate 71 is in contact with and joined to the lower plate 73. The upper surface of the upper plate 72 is in contact with and joined to the power storage module 20. The lower surface of the lower plate 73 is in contact with and joined to the power storage module 20.

A plurality of spaced portions 74 is provided on the outer edge portions 32 of the cooler 70 according to the present embodiment. The spaced portion 74 is provided on the outer edge of the cooler 70. As shown in FIG. 6, the spaced portions 74 are arranged at predetermined intervals along the X-direction.

As shown in FIGS. 6 and 7, an outer edge portion 72A of the upper plate 72 is curved upward in the spaced portion 74. In other words, the diameter of the outer edge portion 72A of the upper plate 72 increases upward in the spaced portion 74. An outer edge portion 73A of the lower plate 73 is curved downward in the spaced portion 74. In other words, the diameter of the outer edge portion 73A of the lower plate 73 increases downward in the spaced portion 74. The middle plate 71 is not curved even in the spaced portion 74.

Therefore, the upper plate 72 and the middle plate 71 are spaced away from each other in the spaced portion 74, and a space is secured between the upper plate 72 and the middle plate 71. The lower plate 73 and the middle plate 71 are spaced away from each other in the spaced portion 74, and a space is secured between the lower plate 73 and the middle plate 71. Each space is filled with the filler 16.

According to the present embodiment, the following actions and effects are achieved.

In the present embodiment, the spaced portion 74 in which the upper plate 72 and the lower plate 73 are spaced away from the middle plate 71 is provided at the end of the cooler 70. Therefore, the filler 16 enters the spaced portion 74 to improve the adhesive strength between the filler 16 and the cooler 70. When an external load is input to the power storage device 10, an inertial force acts on the cooler 70 inside the case 12, causing the cooler 70 to move inside the case 12. Since the adhesive strength between the filler 16 and the cooler 70 is improved, the movement of the cooler 70 is restricted. In other words, the movement of the cooler 70 is restricted by an anchor effect of the filler 16 that fills the space secured in the spaced portion 74. Thus, the movement of the cooler 70 housed in the case 12 can be suppressed inside the case 12.

Although the power storage devices according to the embodiments have been described above, design of the power storage devices can be changed as appropriate without departing from the scope of the disclosure.

For example, the positions of the through holes, cutouts, and spaced portions provided in the cooler 30 etc. are not limited to the positions described in the first to third embodiments. For example, the through holes, cutouts, and spaced portions provided along the short side 30S of the cooler 30 etc. may be omitted.

What is claimed is:

1. A power storage device comprising:
a case;
a power storage module housed inside the case;
a housed member that is housed inside the case and is stacked on the power storage module in a predetermined direction; and
a filler that fills a space between the case and the housed member in an intersecting direction that intersects the predetermined direction, wherein
the housed member has a through hole that extends through the housed member in the predetermined direction and is filled with the filler.

2. A power storage device comprising:
a case;
a power storage module housed inside the case;
a housed member that is housed inside the case and is stacked on the power storage module in a predetermined direction; and
a filler that fills a space between the case and the housed member in an intersecting direction that intersects the predetermined direction, wherein
an edge of the housed member in the intersecting direction has a cutout filled with the filler.

3. A power storage device comprising:
a case;
a power storage module housed inside the case;
a housed member that is housed inside the case and is stacked on the power storage module in a predetermined direction; and
a filler that fills a space between the case and the housed member in an intersecting direction that intersects the predetermined direction, wherein
the housed member includes a plurality of plate-shaped members stacked in the predetermined direction, and
an end of the housed member in the intersecting direction includes a spaced portion in which the plate-shaped members are spaced away from each other.

4. The power storage device according to claim 1, wherein an end of the housed member in the intersecting direction is located inward, in the intersecting direction, of an end of the power storage module in the intersecting direction when viewed in the predetermined direction.

5. The power storage device according to claim 2, wherein an end of the housed member in the intersecting direction is located inward, in the intersecting direction, of an end of the power storage module in the intersecting direction when viewed in the predetermined direction.

6. The power storage device according to claim 3, wherein the end of the housed member in the intersecting direction is located inward, in the intersecting direction, of an end of the power storage module in the intersecting direction when viewed in the predetermined direction.

7. The power storage device according to claim 1, wherein:
a plurality of the power storage modules is provided; and
the housed member is provided between the power storage modules adjacent to each other and provides a conductive connection path between the power storage modules adjacent to each other.

8. The power storage device according to claim 2, wherein:
a plurality of the power storage modules is provided; and
the housed member is provided between the power storage modules adjacent to each other and provides a conductive connection path between the power storage modules adjacent to each other.

9. The power storage device according to claim 3, wherein:
a plurality of the power storage modules is provided; and
the housed member is provided between the power storage modules adjacent to each other and provides a conductive connection path between the power storage modules adjacent to each other.
